(19) United States
(12) Patent Application Publication
(10) Pub. No.: US 2008/0067031 A1
(43) Pub. Date: Mar. 20, 2008

(54) Bill Receiver With Foreign Matter Detection Device

(76) Inventor: Sung-Ching Lin, Taipei (TW)

Correspondence Address: LAW OFFICES OF LAI & ASSOCIATES, P.C., STE 200, 5800 RANCHESTER, HOUSTON, TX, 77036, US

(21) Appl. No.: 11/676,486

(22) Filed: Feb. 19, 2007

(30) Foreign Application Priority Data
Sep. 15, 2006 (TW) 095216542

(51) Int. Cl. G07F 7/04

(52) U.S. Cl. 194/207; 194/206

(57) ABSTRACT

A bill receiver with foreign matter detection device is disclosed. The bill receiver is that an upper base and a lower base, which are formed to be a bill channel, have a plurality of seams corresponding to each other. A holder is disposed under the lower base. A plurality of detection plates disposed upon the holder corresponds to the plurality of seams of the upper and the lower bases. The holder has flexible displacements through a control device. The detection plates then pass through the seams. It then determines whether or not the bill channel has foreign matters through the position of the holder detected by a detection device.

### FIELD OF THE INVENTION

The present invention relates to a bill receiver with a foreign matter detection device, and more particularly to a bill receiver that uses a plurality of detection plates for detecting foreign matters.

### BACKGROUND OF THE INVENTION

As electronic technology advances and labor cost rises, more and more jobs are performed by automatic machines such as vending machines and money changing machines. Originally, automatic machines are used mainly for coins with a lower dollar amount, and characteristics including volume, density and conductivity are used for identifying real coins. As automatic machines are used for transactions of a higher dollar amount, dollar bills become an item that automatic machines must be able to handle and process.

Traditionally, an automatic machine usually installs an anti-counterfeit machine to receive an inputted dollar bill, and a general anti-counterfeit machine uses a roller to read dollar bills. Once a dollar bill is put into the slot of an anti-counterfeit machine, the light at the opening of the slot will be blocked to start a main roller. After the dollar bill enters into the anti-counterfeit machine, an optical sensor will start operating. Each sensor has light emitting diodes capable of emitting infrared lights and visible lights with different wavelengths, and being a photo transistor used as a receiver, so that the reflectance ratio, transmission ratio and fluorescence of different portions of the dollar bill can be detected. Since dollar bills of different face values have their own characteristics, the anti-counterfeit machine can determine the face value of the dollar bill based on these characteristics.

The main reason of using vending machines for selling merchandise resides on saving the labor force, and thus these machines can be used a substitute of labor force. If the vending machines are situated at a place with less customers or at an off-peak time, unauthorized persons may use special tools to draw the dollar bills out from the anti-counterfeit machine or take away the dollar bills from a bill storage container of the automatic machines. Therefore, automatic machines often come with a design that prevents unauthorized people to draw back the dollar bills as shown in FIG. 1.

Referring to FIG. 1 for a schematic view of a conventional anti-counterfeit machine, the dollar bill 11 is passed through a bill input inlet of the anti-counterfeit machine first, and then passed through a track 12. To prevent the dollar bill 11 from being drawn out, the track 12 is generally designed with a curved shape, such as the track 13, and then the dollar bill 11 is checked by an optical recognition device 14 to identify the dollar bill 11. If the dollar bill 11 is determined to be a real dollar note, then the dollar bill 11 will be put into a bill container 15. If the dollar bill 11 is determined to be a counterfeit, then the dollar bill 11 will be returned from another bill output outlet or the original bill input inlet.

Generally, a curved track is designed to prevent the dollar bills from being drawn out, but such design can be cracked easily. For example, a string can be stuck onto a real dollar bill when the dollar bill is put into the inlet, and then another counterfeit is put into the inlet, so that when the anti-counterfeit machine returns the counterfeit, the string can be used to draw out the real dollar bill. As a result, the anti-counterfeit machine has a count of one dollar bill, but actually it has not received the dollar bill into the account. If a thief asks for a return of the dollar bill, the anti-counterfeit machine will return a dollar bill, and thus it will cause losses to a bank or a related party.

Referring to FIG. 2 for a schematic view of the structure of a conventional anti-drawing device, the anti-drawing device 20 comprises a main roller 21, a secondary roller 22, two support plates 25, 26, an arc guide plate 23 and a protecting plate 24. Two support plates 25, 26 are installed at both ends of the main roller 21 and the secondary roller 22, and the main roller 21 and the secondary roller 22 are rotated in opposite directions under the support of the support plates 25, 26, and a bill channel is disposed between the main roller 21 and the secondary roller 22. The main roller 21 is comprised of a plurality of circular plates 27, and a protruding object 28 is extended from a portion of the external surface of each circular plate 27 for winding a string that is entered into a bill input inlet together with the dollar bill 11. A guide plate 23 is situated at the rear of the main roller 21, and a bill channel is formed between the guide plate 23 and the main roller 21.

In view of the foregoing shortcomings of the prior art that cannot actively detect whether or not a string is entered, the inventor of the present invention based on years of experience from conducting research and experiments in the area of foreign matter detection finally invents a bill receiver with a foreign matter detection device to overcome the foregoing shortcomings.

### SUMMARY OF THE INVENTION

Therefore, it is a primary objective of the present invention to provide a bill receiver with a foreign matter detection device, and the bill receiver uses a plurality of detection plates for detecting foreign matters.

To achieve the foregoing objective, the present invention discloses a bill receiver with a foreign matter detection device, comprising an upper base, a lower base, a holder and a detection device. The upper base has a plurality of first seams, and a bill channel is formed between the lower base and the upper base, and the lower base has a plurality of second seams corresponding to the positions of the first seams. The holder is installed in the lower base and has a plurality of detection plates and a control device. The detection plates are installed at an end of the holder, and the position of each detection plate corresponds to one of the positions of the first seam and one of the positions of the second seams. The control device is fixed at another end of the holder, such that the holder is contractible and displaceable in the lower base, and the detection plate is passed through the first seam and the second seam. The detection device is provided for detecting the position of the holder to determine whether or not a foreign matter exists in the bill channel.

Since one of the beneficial effects of the bill receiver with a foreign matter detection device in accordance with the present invention is to detect a tiny foreign matter such as a 0.6 mm string, the invention can achieve the anti-theft effect.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of a conventional anti-counterfeit machine;

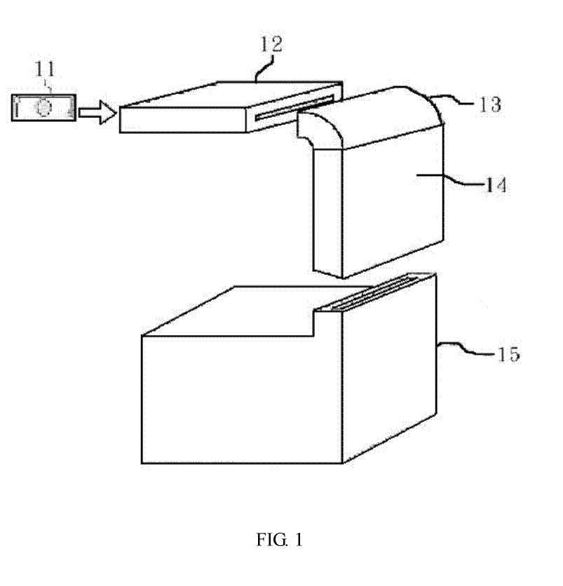

FIG. 2 is a schematic view of a conventional anti-drawing device;

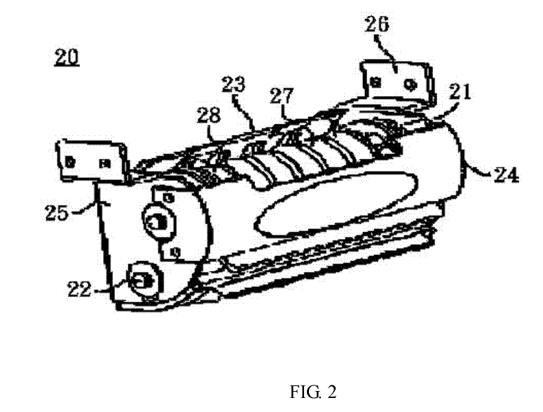

FIG. 3 is a cross-sectional view of a bill receiver with a foreign matter detection device of the present invention;

FIG. 4 is another cross-sectional view of a bill receiver with a foreign matter detection device of the present invention;

FIG. 5 is a schematic view of a control device of the present invention;

FIG. 6 is a schematic view of a detection device of the present invention;

FIG. 7 is a schematic view of another detection device of the present invention; and

FIG. 8 is a cross-sectional view of another bill receiver with a foreign matter detection device of the present invention.

### DETAILED DESCRIPTION OF THE PREFERRED EMBODIMENTS

The objectives, characteristics and advantages of the present invention will be described in more detail hereinafter with reference to related drawings that show various embodiments of the bill receiver of the invention. In the following figures, the same numerals are used to label the same respective elements for the illustration purpose.

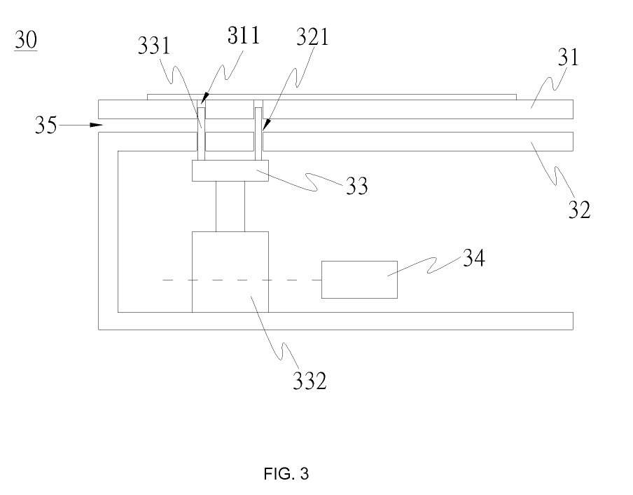

Referring to FIG. 3 for a cross-sectional view of a bill receiver with a foreign matter detection device in accordance with the present invention and the bill receiver with a foreign matter detection device 30 is operated for the detection, the bill receiver 30 comprises an upper base 31, a lower base 32, a holder 33 and a detection device 34. The upper base 31 has a plurality of first seams 311, and a bill channel 35 is formed between the lower base 32 and the upper base 31, and the lower base 32 has a plurality of second seams 321 corresponding to the position of the first seams 311. The holder 33 is installed in the lower base 32, and the holder 33 has a plurality of detection plates 331 and a control device 332, and the detection plates 331 are installed at an end of the holder 33, and the position of each detection plate 331 corresponds to one of the positions of the first seams 311 and one of the positions of the second seams 321. The control device 332 is fixed at another end of the holder 33, such that the holder 33 is contractible and displaceable in the lower base 32, and the detection plate 331 is passed through the second seam 321, the bill channel 35 and the first seam 311. The detection device 34 is provided for detecting the position of the holder 33 to determine whether or not a foreign matter exists in the bill channel 35.

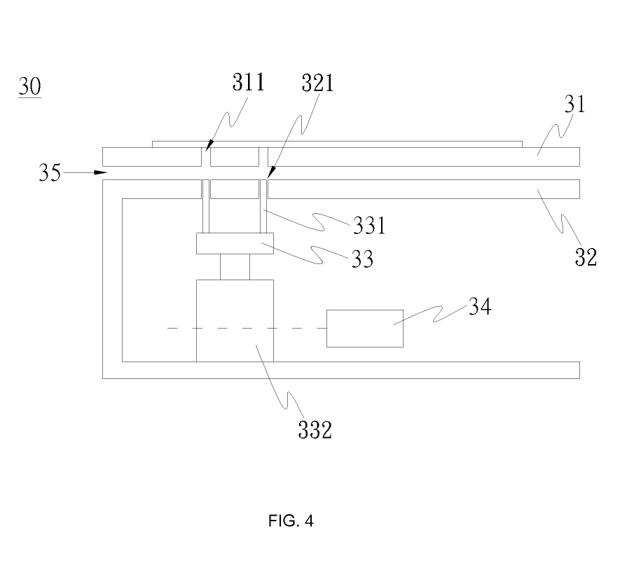

Referring to FIG. 4 for a cross-sectional view of a bill receiver with a foreign matter detection device in accordance with the present invention when the bill receiver with a foreign matter detection device 30 is not operated yet, the bill receiver 30 comprises an upper base 31, a lower base 32, a holder 33 and a detection device 34. The upper base 31 has a plurality of first seams 311, and a bill channel 35 is formed between the lower base 32 and the upper base 31, and the lower base 32 has a plurality of second seams 321 corresponding to the first seams 311. The holder 33 is installed in the lower base 32, and the holder 33 has a plurality of detection plates 331 and a control device 332, and the detection plates 331 are installed at an end of the holder 33, and the position of each detection plate 331 corresponds to one of the positions of the first seams 311 and one of the positions of the second seams 321. The control device 332 is fixed at another end of the holder 33, such that the holder 33 is contractible and displaceable in the lower base 32. If the bill receiver is not operated, the end of the detection plate 331 will be passed precisely through the second seam 321 and situated at the same horizontal plane with the external surface of the lower base 32, such that the bill channel 35 allows the dollar bill to be passed through successfully

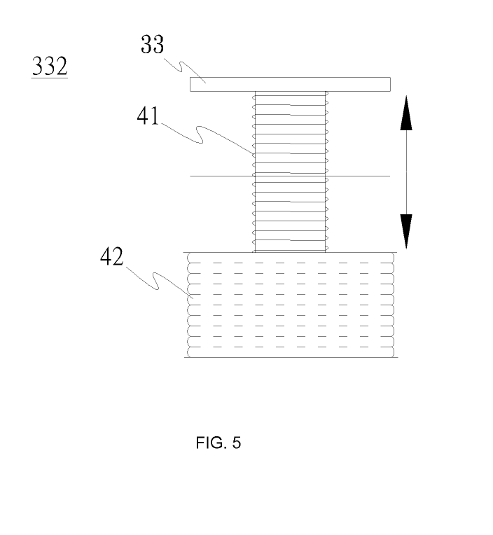

Referring to FIG. 5 for a schematic view of a control device of the present invention, the control device 332 further comprises a resilient element 41 and an electromagnetic element 42. The electromagnetic element 42 is provided for producing a magnetic force to attract the holder 33 to move the holder 33 close to the electromagnetic element 42. If the electromagnetic element 42 does not produce the magnetic force, the resilience of the resilient element 41 moves the holder 33 away from the electromagnetic element 42.

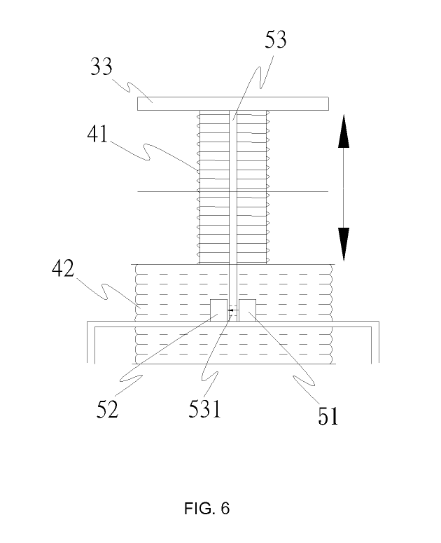

Referring to FIG. 6 for a schematic view of a detection device of the present invention, the detection device 34 further comprises a light emitting device 51, a light receiver 52 and a slab 53. The slab 53 is fixed on the holder 33, and the slab 53 has an aperture 531, such that if the slab 53 is moved together with the holder 33 to a predetermined position, the light receiver 52 can receive a light beam transmitted from the light emitting device 51 through the aperture 531, and the light can be used for determining whether or not a foreign matter exists in the bill channel 35. If the light receiver 52 cannot receive the light beam transmitted from the light emitting device 51 through the aperture 531, it is determined that a foreign matter exists in the bill channel 35.

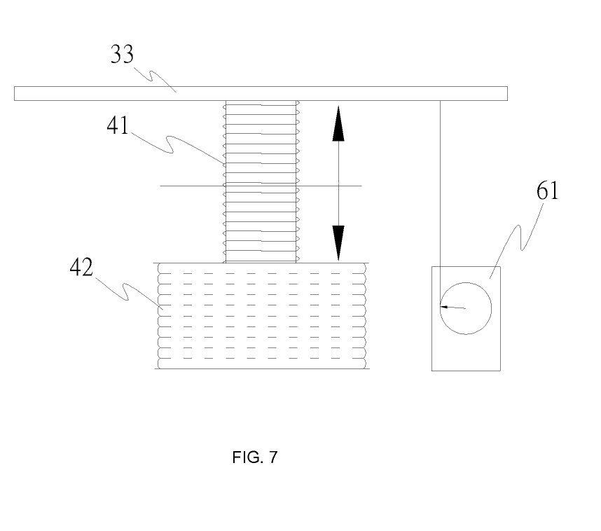

Referring to FIG. 7 for a schematic view of another detection device of the present invention, the detection device 34 is a rotation sensor 61 connected to the holder 33 for producing a rotation angle based on the displacement of the holder 33. If the rotation sensor 61 returns to the rotation angle, it will be determined that no foreign matter exists in the bill channel 35. If the rotation sensor 61 has not returned to the rotation angle, it will be determined that a foreign matter exists in the bill channel 35.

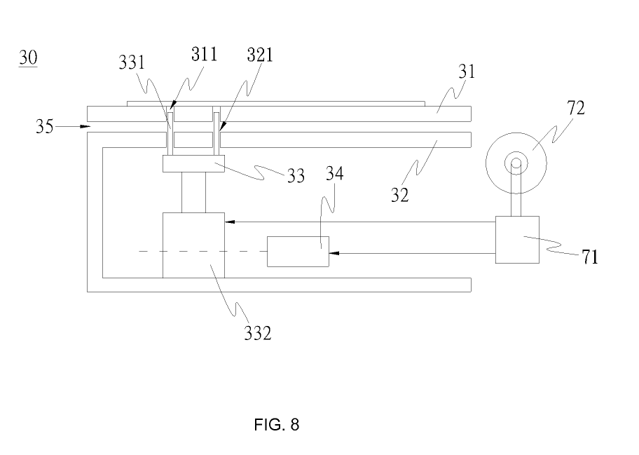

Referring to FIG. 8 for a cross-sectional view of another bill receiver with a foreign matter detection device of the present invention, the bill receiver 30 with a foreign matter detection device comprises an upper base 31, a lower base 32, a holder 33, a detection device 34 and a bill transmission device 71. The upper base 31 has a plurality of first seams 311, and a bill channel 35 is formed between the lower base 32 and the upper base 31, and the lower base 32 has a plurality of second seams 321 corresponding to the positions of the first seams 311. The holder 33 is installed in the lower base 32, and the holder 33 has a plurality of detection plates 331 and a control device 332. The detection plates 331 are installed at an end of the holder 33, and the position of each detection plate 331 corresponds to one of the positions of the first seams 311 and one of the positions of the second seams 321. The control device 332 is fixed to another end of the holder 33, such that the holder 33 is contractible and displaceable in the lower base 32, and the detection plate 331 passes through the second seam 321, the bill channel 35 and the first seam 311. A bill transmission device 71 is provided for detecting the number of rotations of a conveying roller 72 in the bill channel 35 to determine whether or not a dollar bill has passed through the positions of the first seam 311 and the second seam 321. The detection device 34 is provided for detecting the position of the holder 33 to determine whether or not a foreign matter exists in the bill channel 35.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bill receiver with a foreign matter detection device, comprising:
an upper base, having a plurality of first seams;
a lower base, defining a bill channel between said upper base and said lower base, and having a plurality of second seams disposed at positions corresponding to said plurality of first seams respectively;
a holder, installed in said lower base, and having a plurality of detection plates and a control device, and said detection plate is installed at an end of said holder, and the position of said each detection plate corresponds to one of the positions of said first seams and one of the positions of said second seams, and said control device is fixed to another end of said holder, such that said holder can be contracted and displaced in said lower base, and said detection plates pass through said first seams and said second seams; and
a detection device, for detecting the position of said holder to determine whether or not a foreign matter exists in said bill channel.

2. The bill receiver of claim 1, wherein said control device further comprises a resilient element and an electromagnetic element, and said electromagnetic element is provided for producing a magnetic force to attract said holder to move said holder close to said electromagnetic element, such that if said electromagnetic element does not produce said magnetic force, the resilience of said resilient element will move said holder away from said electromagnetic element.

3. The bill receiver of claim 1, wherein said detection device further comprises a light emitting device, a light receiver and a slab, and said slab is fixed on said holder and said slab has an aperture, such that if said slab moves together with said holder to a predetermined position, said light receiver will receive a light beam transmitted from said light emitting device through said aperture.

4. The bill receiver of claim 1, wherein said detection device is a rotation sensor coupled to said holder for producing a rotation angle based on the displacement of said holder.

5. The bill receiver of claim 1, further comprising a bill transmission device for detecting the number of rotations of a conveying roller in said bill transmission device to determine whether or not a dollar bill has passed through the positions of said first seams and said second seams.

6. A foreign matter detection device, comprising:
a plurality of detection plates, disposed in parallel with each other;
a holder, for installing said detection plates at an end of said holder;
a control device, fixed to another end of said holder, such that said holder is contractible and displaceable; and
a detection device, for detecting the position of said holder to determine whether or not a foreign matter exists based on the position of said holder.

7. The foreign matter detection device of claim 6, wherein said control device further comprises a resilient element and an electromagnetic element, and said electromagnetic element is provided for producing a magnetic force to attract said holder to move said holder close to said electromagnetic element, such that if said electromagnetic element does not produce said magnetic force, the resilience of said resilient element will move said holder away from said electromagnetic element.

8. The foreign matter detection device of claim 6, further comprising a light emitting device, a light receiver and a slab, and said slab is fixed on said holder and said slab has an aperture, such that if said slab moves together with said holder to a predetermined position, said light receiver will receive a light beam transmitted from said light emitting device through said aperture.

9. The foreign matter detection device of claim 6, wherein said detection device is a rotation sensor coupled to said holder for producing a rotation angle based on the displacement of said holder.
